(19) United States
(12) Patent Application Publication
(10) Pub. No.: US 2010/0324972 A1
(43) Pub. Date: Dec. 23, 2010

(54) REAL-TIME, DEMAND-BASED DYNAMIC PRICING SYSTEM AND METHOD

(75) Inventors: Steven R. Brooke, Alpharetta, GA (US); Mark F. Morel, Atlanta, GA (US)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: WHOOP, INC., Atlanta, GA (US)

(21) Appl. No.: 12/814,222

(22) Filed: Jun. 11, 2010

Related U.S. Application Data
(60) Provisional application No. 61/218,555, filed on Jun. 19, 2009.

(51) Int. Cl. G06Q 30/00; G06Q 10/00; G06F 17/30

(52) U.S. Cl. 705/10; 705/14.13; 705/14.25; 705/14.35; 705/400; 707/607; 707/E17.014; 707/E17.005

(57) ABSTRACT

Systems and methods for providing real-time dynamic pricing information for a product based on receipt of a price queries from consumers at point-of-sale. The system receives price queries for a product provided by a consumer at point-of-sale by way of use of a mobile communicating device such as cellphone. The system maintains a database of received price queries. A preset price query threshold value associated with the product is retrieved in response to a received query. A price query count is extracted for the product, the price query count being the number of price queries generated in a predefined sample period. A product price is calculated in real time based on a comparison between the price query count and the threshold values. The consumer may be provided with discounts or coupons based on marketing campaign parameters derived from the price query.

### TECHNICAL FIELD

The present application relates generally to pricing products and services, and more particularly to methods and systems for dynamically pricing products and services.

### BACKGROUND

Dynamic pricing, a type of pricing system that alters a commodity price in accordance with demand patterns, has been around for some time. One of the most successful implementation of dynamic pricing is seen in the airline industry, which employs the technique so artfully that most passengers on any given flight pay different ticket prices. Ticket prices typically vary based on seasons, predicted demand, historical demand, flight sector, flight time, days left for flight, and similar features.

In the retail or e-commerce industry, however, suppliers and retailers have traditionally determined the optimal price for a product based on retrospective demand and inventories of products on hand. For non-commodity goods and services, price depends, in part, on the ebb and flow of supply and demand within a competitive environment. In these sectors, the ability to adjust the product pricing instantaneously would enable greater economic efficiency and ostensibly higher margins.

Recently, various methods have emerged that attempt to dynamically price products. Most of these methods use extensive empirical data such as historical purchase patterns, financial data, stock rates, and inventory data to determine the optimal price for a product. Moreover, some methods incorporate analytics that attempt to predict future demand based on this empirical data. Although these methods provide dynamic pricing information, they require considerable retrospective analysis of data collected over a long period. Due to this data processing requirement, the predicted future demand data can be stale and therefore less robust in addressing short-term demand fluctuations.

Therefore, there is a long-felt but unresolved need for a system or method that provides dynamic pricing information about products in real time. There remains a further need for a system or method that is simple to implement, does not require extensive data analysis, and can be easily configured by the manufacturer or suppliers to provide product pricing information in real time in any given scenario—online or retail.

### BRIEF SUMMARY

Briefly described, and according to one embodiment, the present disclosure describes a computer-implemented method for providing real-time dynamic pricing information. Initially, a price query for a product is received and a database of the received price queries is maintained. The method proceeds to retrieve preset price query threshold values for one or more product parameters. Next, a price query count is extracted, which is the number of price queries generated in a predefined sample period. Finally, the method calculates a product price based on a comparison between the count of price queries and the threshold value.

Another embodiment of the present disclosure presents a system for providing real-time dynamic pricing information. The system includes an input module for receiving price query for a product and a transaction database for storing the received price query. A dynamic pricing module retrieves preset price query threshold values associated with the product, a price query count, which is the number of price queries generated in a predefined sample period. In addition, the dynamic pricing module calculates a product price based on a comparison between the count of the price queries and the threshold values. The system further includes a content generation module for generating a coupon displaying the product price information.

Certain embodiments of the disclosure may provide various technical advantages. For example, certain embodiments may allow manufacturers or suppliers to maximize profits and sales margins by instantaneously varying prices based primarily on current product demand. Further, other embodiments of the system may allow consumers to purchase products at the most optimal price based on current product demand.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment. The drawings are illustrative in nature and are not necessarily drawn to scale.

FIG. 1 is a block diagram illustrating an exemplary environment where embodiments of the present invention are implemented.

FIG. 2 is a block diagram illustrating an exemplary dynamic pricing engine.

FIG. 3 illustrates an exemplary transaction database schema.

FIG. 4 is a flowchart illustrating an exemplary method for providing real-time dynamic pricing information for a product.

FIG. 5 is a flowchart illustrating an exemplary method for calculating real-time dynamic pricing information for a product.

FIG. 6 is a flowchart illustrating an exemplary method for setting threshold values for parameters associated with a product

FIG. 7 is a block diagram illustrating an exemplary implementation of the dynamic pricing system.

### DETAILED DESCRIPTION

For promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

### System Overview

Embodiments of the present disclosure relate to aspects of an electronic system (e.g., Internet or mobile network accessible) that facilitates real-time dynamic pricing of products or services. Consumers, shopping online or in a retail store, can send a price query to the system using a mobile or stationary computing device such as a cell phone, a PDA, a pocketbook, a laptop, a desktop, or any other similar device (even as they contemplate the purchase of a product) to ascertain the instantaneous product price. Based on a count of the price queries received for a product or group of products in a given timeframe, the system applies predefined algorithms or rules to generate a dynamic price. This price is primarily dependent on the current demand as inferred from the price query count over the given timeframe. For example, if, on a given day, 20 consumers send price queries about a Coca-Cola® product, the price offered to the 20 consumers may be as low as 50¢. Alternatively, if 2000 people send price queries for the same Coca-Cola product in a single day, the first 20 consumers may be offered a price of 50¢, while the next thousand consumers may be offered a price of $1.00, and the remaining consumers may be offered a price of $1.50. If the consumers send a query for the same product on the next day, the system may return a different price offer depending on the price query count that day. Here, ‘price query count’ or ‘price query rate’ refers to the number of price queries generated by consumers for a specific product or group of products in a specific period. The period may be a minute, an hour, a day, a week, or a month.

The electronic system may further incorporate consumer or product location information into the predefined algorithms to generate product prices targeted to specific locations or regions. In this implementation, along with price query information the system may employ other factors as well, such as local weather information, regional population, economic data (i.e., consumer price index, monthly sales for retail and food services, inventories, sales, monthly wholesale trade, and new residential construction) and other such region-specific information to generate the dynamic product pricing.

A particular electronic system may allow retailers or suppliers to offer special pricing to individuals based upon their buying habits, allegiance, referrals, etc. For example, a frequent shopper may receive a loyalty discount in addition to the dynamic price returned by the pricing engine.

This system does not use extensive data warehousing and analytics or consumer profile information to determine the relative demand for a product. Instead, the system utilizes predefined algorithms or rules that are set by content developers, or marketing executives of organizations and product companies that primarily factor in price queries generated by consumers; the more the demand for a product, the lower the discounted value of the product. The developers can set various price query thresholds, location-based thresholds, or external data thresholds with associated price or discount levels. The price query count may be compared with these thresholds to determine the dynamic product price in real-time.

### Exemplary Environment

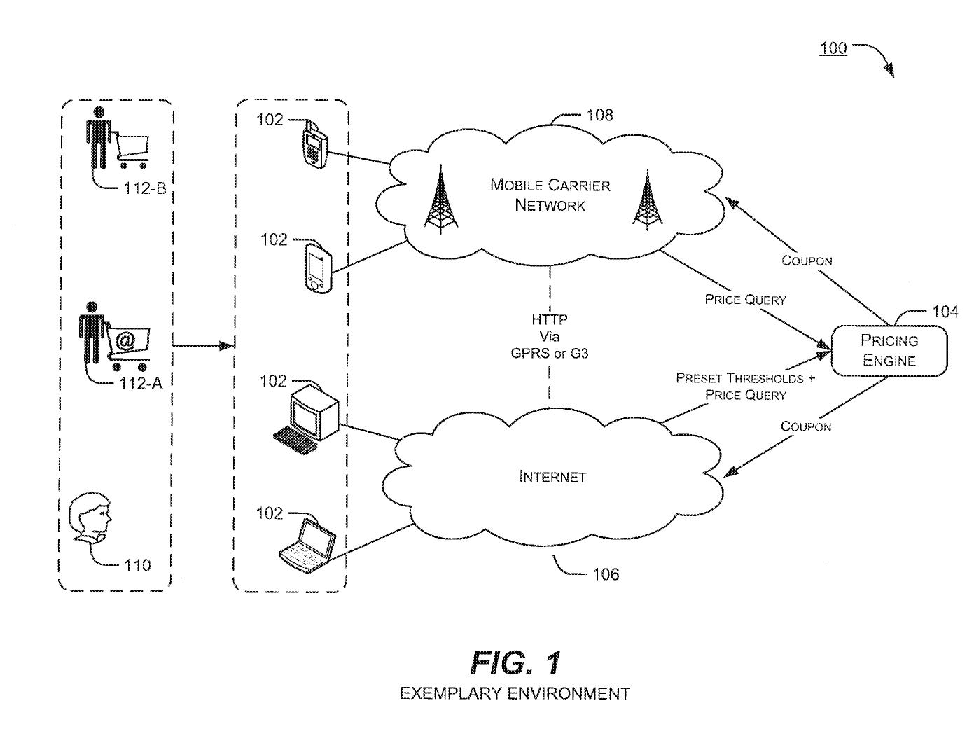

FIG. 1 illustrates an exemplary environment 100 where embodiments of the present invention can be implemented. As shown, the environment 100 includes one or more computing devices 102 (such as cell phones, PDAs, desktops, laptops, and notebooks, scanners, touch screen pads, etc.) connected to a pricing engine 104 through one or more networks such as the Internet 106 or a mobile carrier network 108.

Developers 110, present on the computing devices 102 can develop campaign content for one or more products. Moreover, multiple developers 110 may develop campaigns simultaneously for the same product or for different products. A campaign may typically include one or more of: product name and ID, price query thresholds, external data based thresholds, location-based thresholds, price or discount levels associated with the thresholds, applicable additional discounts, and other such campaign specific information. This campaign information is stored in the pricing engine 104. The pricing engine 104, upon receiving price queries, logs the price query in a transaction database, identifies the relevant campaign and related products, and retrieves the threshold values and associated price levels related to the queried product. Based on a comparison of the threshold values and the price query count, the pricing engine 104 calculates a dynamic price or discount for the product and provides this information to the consumer 112 as a coupon.

The environment 100 may be an online shopping store, where the consumer (such as online shopper 112-A) connects to a web portal through a stationary or mobile computing device 102 and queries the pricing engine 104 for the product price. The pricing engine 104 calculates the price and provides this information back to the shopper 112-A as a pop-up screen, a short message service (SMS), an email, or any such means. For purposes of the present disclosure, the term “consumer” is generally synonymous with “customer,” “user,” or “shopper.”

Alternatively, the environment 100 may be a retail store, where the consumer 112 (such as retail shopper 112-B) sends price queries while contemplating purchase of a product. In this case, the retail shopper 112-B may utilize a mobile computing device 102 such as a cell phone, PDA, or pocketbook, to communicate with the pricing engine 104 (utilizing the mobile carrier network 108), or a stationary computing device such as a PC, electronic device, or a notebook installed near the product. In this case, the computing device 102 communicates with the pricing engine 104 using the Internet 106 or the mobile carrier network 108.

It will be understood that the consumer may send the price query using various methods, depending on the computing device 102 used. For example, the consumer may send an SMS, or use a special purpose application or interface installed on the computing device 102. Other methods may also be contemplated by people skilled in the art, which are not beyond the scope of the present invention. Moreover, the consumer may send price query information by entering a product code or a product name, scanning a product bar code, selecting an icon or button on a graphical interface, or any other such means. In return, the pricing engine 104 delivers a price or discount coupon to the computing device 102 as scannable electronic coupon, or a printable coupon.

Some countries levy higher taxes on products or services in cities as compared to the suburbs, which results in varied product prices. In addition, demand for a product may vary in different locations (for example, consumers 112 demand more beachwear in California as compared to Washington). Moreover, product prices vary considerably between retail outlets and factory outlets. Therefore, allowing developers 110 to set different prices or discounts for a product depending on the location or type of retail store can optimize product prices considerably, making the system more profitable to both suppliers and consumers 112. Location based pricing may also be useful for online shopping stores that service multiple countries, allowing them to offer different pricing for consumers in different countries.

To determine the consumer or product location the pricing engine 104 may utilize the consumer's IP address, mobile carrier network information (triangulation), GPS information, unique computing device codes, or machine IDs. When a consumer sends a query, this location information may be extracted from the query to determine the user's location. It will be understood that other methods to determine a consumer or product location may be employed, such as assigning unique codes to products in different locations, or providing unique codes to retailers. When a consumer enters the unique product code or the unique retailer code, the pricing engine 104 can determine the product location. Depending on the computing device 102 and the information extracted from the price query, the pricing engine 104 can determine an approximate location such as country, closest city, town, suburb, or postal code, or the pricing engine 104 may be able to determine the exact consumer or product location.

As described previously, the pricing engine 104 may also utilize consumer information to provide additional discounts to loyal consumers or frequent shoppers such as consumers 112 who generate numerous queries, or who complete a number of transactions. To this end, the pricing engine 104 may require consumers to register with the pricing engine 104. Thereafter, the pricing engine 104 maintains a count of the price queries generated by a consumer or the count of completed transactions. The pricing engine 104 may receive information regarding completed transaction from the POS (not shown) whenever a coupon has been utilized.

Moreover, the pricing engine 104 may utilize various techniques to identify a consumer when the consumer generates a price query. For example, the pricing engine 104 may store consumer credentials such as user name, phone number, address, ID, login information, or IP address. Subsequently, consumers 112 may be identified by comparing the consumer's cell phone number login or registration details, unique user code, IP address, or any other consumer information with the stored user credentials.

The loyalty discount may be authorized by the supplier or the retailer. For instance, a supermarket may add an additional discount to the dynamic price offered by the supplier based on a customer's loyalty to the supermarket. To this end, suppliers may allow retailers to alter the additional discount section of a product campaign. Here, retailers may define thresholds for customer eligibility. For example, if a customer purchases products worth $500 in a month, the customer may be eligible for the additional discount. Alternatively, suppliers may offer the additional discount to loyal consumers based on the count of price queries generated.

In some instances, when the pricing engine 104 utilizes information regarding completion of transactions, the engine gathers this information from the retail stores or the online web portals in real time or at predetermined times. For instance, the pricing engine 104 may be connected to coupon scanners in retail stores. Whenever a checkout executive enters the coupon code in a scanner or on a network connected computing device, the device may transmit the coupon information to the pricing engine 104, which stores the count of completed transactions. Alternatively, retail stores may provide information about all utilized coupons to the pricing engine 104 at regular intervals.

Additionally, as will be understood, the environment 100 includes other engines, modules, and functionality not described herein, as will occur to one of ordinary skill in the art. Further, the environment 100 is not intended to be limited by the specific networks, modules, devices, and other components shown and described herein. As will be understood and appreciated, the architecture of the environment 100 may vary as will occur to one of ordinary skill in the art.

### Exemplary System

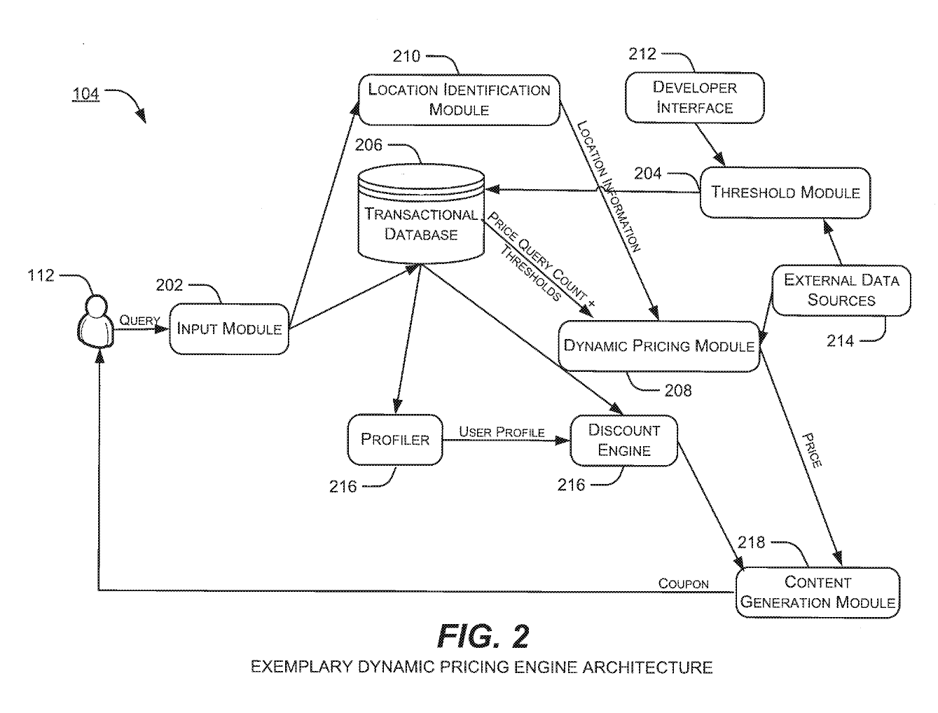

FIG. 2 illustrates an exemplary dynamic pricing engine, such as the pricing engine 104 providing instantaneous pricing information to consumers 112 based on price query rates. As shown, the pricing engine 104 includes an input module 202 for accepting price queries, a threshold module 204 configuring threshold values for one or more product parameters and transaction database 206 storing received price queries. The pricing engine 104 further includes a dynamic pricing module 208 that calculates the price or discount offered for a product based on a comparison of the threshold values with the price query count. Apart from these modules, the pricing engine 104 may include numerous other modules and databases, which will be described in detail in the following sections.

### Input Module

The input module 202 accepts price queries from consumers 112 and forwards the queries to various modules or databases that further utilize this information. The price query may include product code or ID, a campaign code, a product name, a bar code, or any other similar information that may be useful to identify the product. This information is provided to the transaction database 206. Along with the price query, the input module 202 may receive additional information, such as consumer location information, name, phone number, IP address, login details, or any other such information that may be useful to qualify the consumer 112 or the consumer's present location. A particular input module 202 may forward this additional information to other modules or databases such as a location identification module 210 or the transaction database 206.

### Threshold Module

The threshold module 204 allows campaign developers 110 to build sale/price campaigns using a developer interface 212 and external data sources 214. The developer interface 212 may be a browser-based access to the pricing engine 104 that provides developers 110 with a simple graphical interface to input threshold values corresponding to various product parameters. Multiple developers 110 may access the threshold module 204 concurrently. Developers 110 can define promotional campaigns with one or more absolute or variance thresholds and progressive price discounts for each threshold using the threshold module 204.

Employing the developer interface 212, which provides all the functionality needed to create and publish the content for the campaign, the developer 110 can select a predefined template to jumpstart the content development or can create the content from scratch. The developer 110 can use features within the threshold module 204 to sequence the content, define transitions, and test the application on various computing device 102 emulators available.

A developer may also incorporate external data into the campaign content from any of the available external data sources 214. Examples of external data sources include localized weather information, traffic data, RSS feeds, social networking content, etc. A swimwear retailer's content developer 110 may vary the price parameters based on the weather—more expensive in the summer and cheaper in the winter, for example.

The threshold module 204 may further prompt the developer 110 to set location-based thresholds with associated price levels. For instance, the threshold module 204 may prompt the developer 110 to distinguish between suburbs and major cities, retail and factory outlets, or different locations based on population, weather, local taxes, etc.

### Transaction Database

The transaction database 206 includes information about the price queries, products, and campaigns for all active campaigns. The transaction database 206 may be refreshed in real-time by the input module 202, threshold module 204, or the location identification module 210 and stale data may be purged every few minutes, hours, days, or weeks. As described, the transaction database 206 provides information to the dynamic pricing module 208. Further, the transaction database 206 may provide information to other modules such as the location identification module 210, a profiler 216, and a discount engine 218.

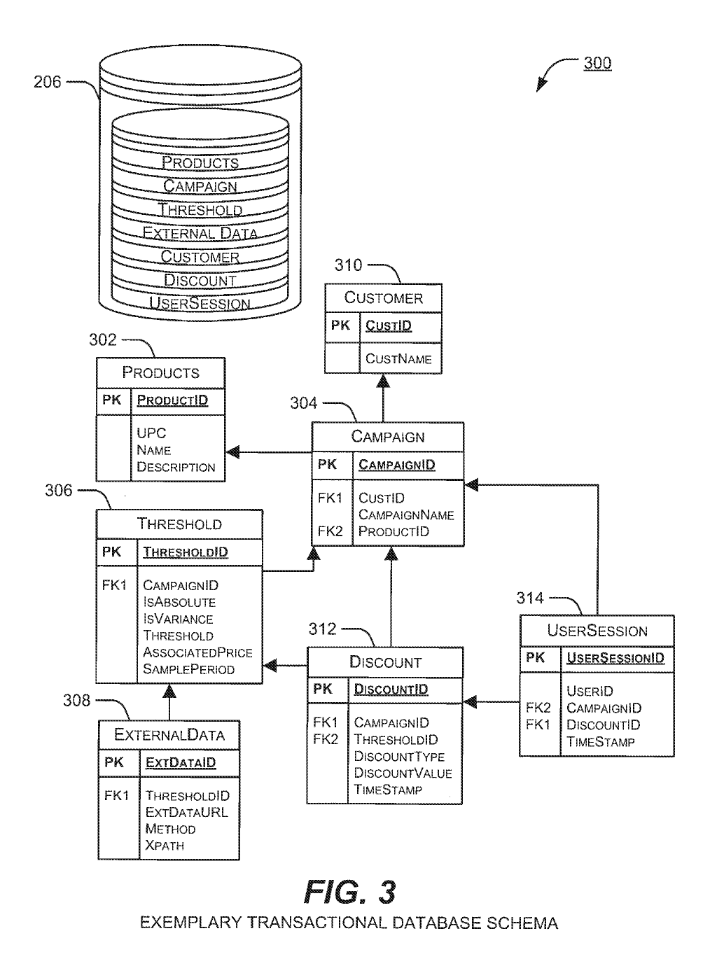

FIG. 3 illustrates an exemplary database schema 300, which may store data in a relational fashion. A typical relational database includes a plurality of tables, each table containing a column or columns that other tables can link to in order to gather information from that table. By storing this information in another table, the transaction database 206 can create a single small table with the locations that can then be used for a variety of purposes by other tables in the database. FIG. 3 illustrates some exemplary tables that may be present in the transaction database 206. It will be understood, however, that the number of tables, specific tables shown, data in the tables, and the relation between the tables may vary depending on the particular embodiment, without departing from the scope of the present disclosure.

The schema 300 includes a product table 302, which catalogues all the products currently campaigned by one or more retailers or suppliers. This table typically, includes unique product IDs, product names, or product descriptions. This table may be associated with a campaign table 304, which stores all active campaigns along with their campaign ID, developer ID, campaign name (if available), and the product IDs of the products associated with the campaign.

The transaction database 206 further includes a threshold table 306, which stores all the threshold values input into the threshold module 204. Some exemplary data fields include campaign ID, threshold values, price associated with each threshold value, absolute or variance thresholds, and the sample period. This table 306 may be associated with another table (external data table 308) that stores threshold values related to external and location-based data. This table may include fields such as external data ID, threshold ID, external data source ID, associated price or discount level, location threshold, etc.

In addition to these tables, the transaction database 206 may include other tables and data fields that the pricing engine 104 may utilize in certain embodiments. For example, the transaction database 206 may include a consumer table 310 where details of the consumer 112 are stored, a discount table 312 that includes details about additional discounts available for the product, and a consumer session table 314, which stores the complete transaction details between the consumer 112 and the pricing engine 104. Some exemplary data fields in these tables may be consumer name, consumer ID, discount type, discount value, time limit on the discount, or discount ID. Other data fields (not shown) may include consumer address, number of price queries generated by the consumer, number of price coupons utilized, most frequently queried products, and most frequently bought products. As will be understood and appreciated, virtually any type of data or information related to products, campaigns, price calculation, consumer information, and session information may be stored in the transaction database 206.

The transaction database 206 may be updated in real time or on an intermittent basis. As will be further understood, the specific database shown and described is intended to be illustrative only and actual embodiments of the present pricing engine 104 include various database structures, schemas, etc.

### Dynamic Pricing Module

Returning to FIG. 2, the dynamic pricing module 208 receives data from the input module 202 and the transaction database 206, calculates the dynamic price for the queried product, and returns the price information to a content generation module 220. To this end, the dynamic pricing module 208 retrieves the threshold values from the transaction database 206 along with any external data related to the queried product's campaign from the external data sources 214. The retrieved price query count is compared with the threshold values and depending on the comparison output, the associated price or discount level is provided to the content generation module 220, which generates a coupon for delivery to the consumer 112.

When more than one threshold type is configured for a product (price query threshold, external data threshold, location-based threshold), the dynamic pricing module 208 may assign weights to each threshold type and their associated price or discount. Depending on the weights assigned, a final price or discount value may be provided to the content generation module 220

### Other Module(s)

The location identification module 210 determines the current location of the consumer 112 or the product based on the data received from the input module 202. This location information is provided to the dynamic pricing module 208, which may apply location restrictions on the threshold values to generate a product price that is tailored to the consumer's location. The functionality of this module will not be described extensively, as methods to determine consumer or product location are described sufficiently in the art.

The profiler 216 classifies consumers 112 into one or more profiles and provides this information to the dynamic pricing module 208. The dynamic pricing module 208 may consider the consumer's profile information while calculating the dynamic product price. Alternatively, the profiler 216 may provide the consumer's profile information to the discount engine 218, which provides a profile-specific discount, independent of the dynamic price calculated. This discount may be offered by the retail store, or by the supplier/manufacturer. The profiler 216 may utilize multiple methods for the classification. Some of the methods include classifying consumers based on the number of price queries generated, classifying consumers based on the number of transactions completed, importing any loyalty program information maintained by the retailer, etc. It will be understood that this list is not exhaustive and other known methods for classifying consumers into categories may be utilized without departing from the scope of the present invention.

The content generation module 220 generates price coupons and selects the most appropriate coupon format depending on the consumer's computing device 102. To this end, the content generation module 220 may extract computing device information from the input module 202 to identify the type of consumer device. Based on the identification, a coupon is generated. For example, if the consumer device is a cell phone, the content generation module 220 may generate an e-coupon with a scannable bar code. If the consumer device is a desktop or laptop, the module may generate a printable coupon or display the product price in a pop-up screen, SMS, email, or any other such medium. In addition to the direct communication method to the consumer's computing device 102, alternative communication methods may include publishing the price coupon via social networks, RSS feeds, blog sites, in-store electronic kiosks, or any other method of mass electronic communication.

### Exemplary Method(s)

The following sections describe exemplary methods for carrying out one or more embodiments of the present disclosure. The methodology described herein is generally intended to describe various features and functionality of various system components described previously. The order in which the methods are described is not intended to be construed as a limitation and any number of the described method blocks can be combined in any order to implement the method, or an alternate method. Additionally, individual blocks may be deleted from the methods without departing from the spirit and scope of the subject matter described herein. Furthermore, the method can be implemented in any suitable hardware, software, firmware, or combination thereof.

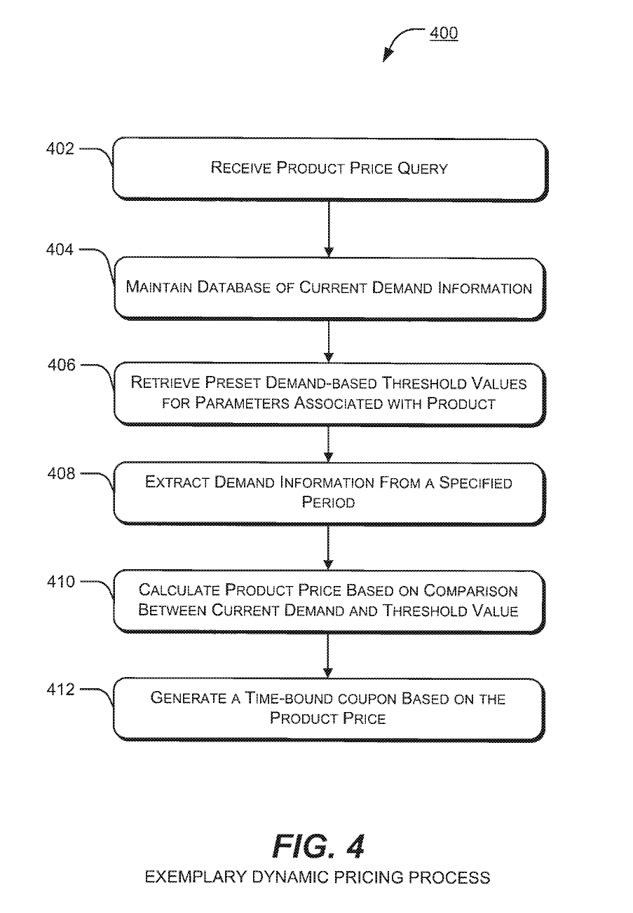

FIG. 4 illustrates an exemplary method 400 for providing real-time dynamic pricing information. At step 402, the input module 202 receives a product price query from one or more consumers 112. To this end, the input module 202 may be coupled to the computing devices 102 via the Internet 106, or a mobile carrier network 108. Moreover, consumers 112 may employ PDAs, cell phones, notebooks, laptops, desktops, and other similar devices to communicate with the pricing engine 104. The price query may include information about the product, consumer location information, consumer specific information, or any other information useful to qualify the product, the consumer location, or the consumer 112.

Next, the method 400 maintains a database of the received price queries (at step 404). The transaction database duly logs each price query received by the input module 202 along with a query timestamp indicating the exact query generation time. The transaction database 206 may also store any additional information obtained with the price query. For instance, the transaction database 206 may store the product ID, product name, consumer name, consumer location, etc.

At step 406, the method 400 proceeds to retrieve preset price query threshold values associated with the product. The threshold values may be absolute or variance values. In some embodiments, the dynamic pricing module 208 may retrieve any other thresholds configured for the product such as location-based thresholds. In addition to these parameters, external data may also be included, for example, weather information, financial status, etc.

Next, at step 408, the price query count is extracted from a specific sample period. The developers 110 can vary the sample period using any range from minutes, hours, days, weeks, or months. For example, in one campaign, the developer 110 may set the sample period to half and hour, so price queries (for the product) generated in the last half hour will be filtered from the transaction database 206. Alternatively, the transaction database 206 may store the price query rate for each product as the number of price queries received per hour. In this case, the method 400 merely extracts the price query rate from the transaction database 206.

The method 400 proceeds to calculate the product price based on a comparison between the price query rate and the threshold values (step 410). As mentioned earlier, the threshold values may be variance or absolute values and the developer 110 may set one or more threshold values. If the values are absolute, the dynamic pricing module 208 compares the price query count with the one or more threshold values. If a single threshold value is defined, the dynamic pricing module 208 determines whether the number of price queries are lesser than or greater than the threshold value. If there are multiple threshold values, the dynamic pricing module 208 determines which threshold value is exceeded. The highest threshold exceeded will be used. If the values are variance, the dynamic pricing module 208 compares the price query count with a target value. Depending on the variance of the price query count with the target value, different price levels may be applied. Once the dynamic pricing module 208 determines which threshold is exceeded, the pricing level associated with the threshold is retrieved from the transaction database 206.

In addition to the price query thresholds, the developer 110 may set threshold values based on external data such as weather, consumer price index, monthly sales, inventory, and residential construction and based on consumer or product location. For instance, the developer of a winter-wear clothing line may specify a certain price if the temperature in a certain locality exceeds 20° C. and a different price if the temperature drops below 10° C. In this situation, once the dynamic pricing module 208 extracts the product or consumer location, the real-time weather information for that location may be retrieved from the external data sources 214 and based on the temperature, the dynamic pricing module 208 may retrieve the associated pricing level.

When threshold values are set based on more than one product parameter, weights are assigned to the parameters. In one embodiment, the weights may be configurable and the developer 110 may assign or alter the weights at any time during the campaign. Alternatively, the threshold module 204 may pre-assign the weights. The dynamic pricing module 208 applies the weights to the thresholds and combines the weighted prices to determine the final product price.

At step 412, the content generation module 220 generates a coupon/certificate based on the calculated product price. In some embodiments, the coupon or certificate may be time-bound or may expire after a specific period, such as an hour, or a day. The coupon may be delivered to the consumer 112 through a communication media, such as the Internet 106, through an SMS, through a mobile-based application, an email, or through a web-based application, without departing from the scope of the present invention. On receiving the coupon, the consumer 112 may decide to purchase the product. In case the coupon is displayed on a mobile computing device 102, the consumer 112 may present the digital coupon at the checkout desk where it can be scanned. Alternatively, if the coupon is displayed on a stationary computing device 102, the consumer 112 may print the coupon. Other media may be used to present the coupon at the checkout counter; for example, the consumer 112 may receive or download the coupon onto an RFID device, which may be scanned by an RFID scanner at the checkout desk. In case of online stores, the coupon may be an e-coupon that would be incorporated in the product price automatically once a product is purchased. It will be understood that various delivery and coupon presentation methods exist and all these methods and techniques are within the scope of the present invention.

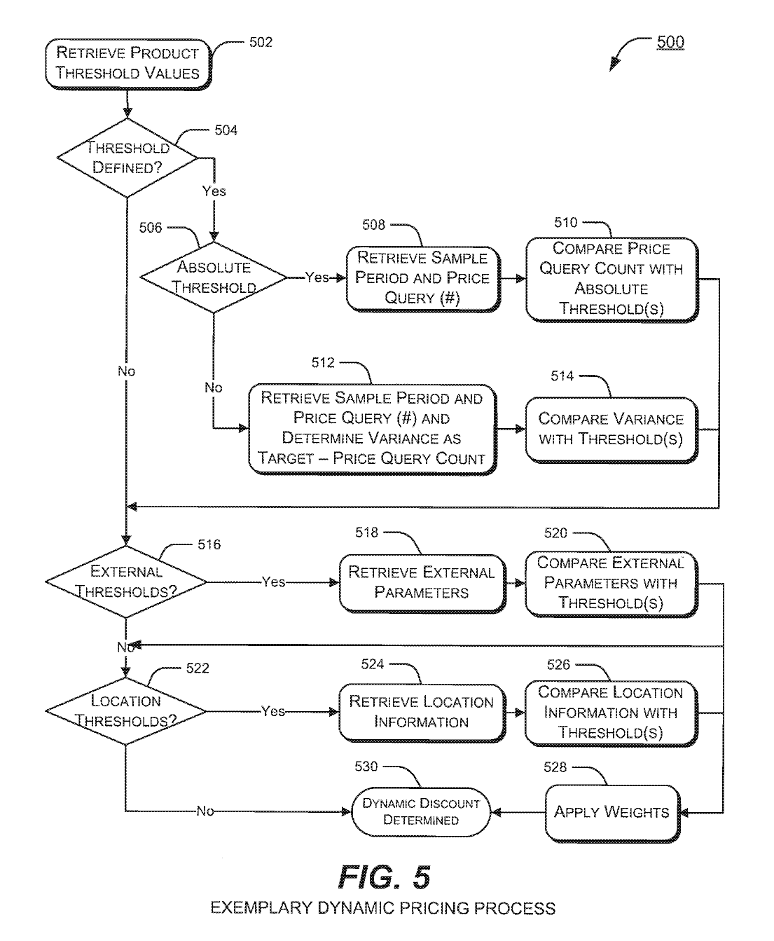

FIG. 5 illustrates an exemplary method for calculating the dynamic pricing information for a product. At step 502, the method 500 retrieves threshold values for a particular product.

Next (step 504), the method 500 determines whether the threshold values are defined. If yes, the pricing module 208 determines whether absolute threshold values are configured at step 506. If yes, the sample period and the price queries are retrieved from the transaction database 206 at step 508. The dynamic pricing module 208 filters the price query information according to the sample period to obtain a price query count, which is compared with the absolute threshold values at step 510. One or more threshold values may be configured by the developer 110. Upon comparison of the price query count with the threshold value, the dynamic pricing module 208 can determine the product price associated with the relevant threshold value.

If variance threshold is utilized (‘no’ path from step 506), the method proceeds to step 512 where the target value, the threshold values, and the price query count are retrieved from the transaction database 206. The dynamic pricing module 208 calculates the variance value as the difference between the target value and the price query count for a specific period. The variance value is then compared with one or more threshold values at step 514 and the appropriate product price is retrieved based on this comparison.

Proceeding to step 516, the method 500 determines if any external parameter threshold values are configured. If yes, the dynamic pricing module 208 retrieves the external data parameters from the external data sources 214 (at step 518) and at step 520 compares these parameter values with the threshold values (set by the developer 110). If the current parameter value exceeds the threshold, one price is application; else, another price is applicable.

Next, and in case external parameters were not configured (no path from step 516), the dynamic pricing module 208 determines if location-based thresholds exist at step 522. If yes, the module, at step 524, extracts the consumer or product location information from the location identification module 210. This information is compared with the thresholds, and the appropriate price or discount levels are retrieved at step 526. The dynamic pricing module 208 applies the threshold weights on the price information obtained at the output of steps 510, 514, 520, and 526 to determine a final product price at steps 528 and 530.

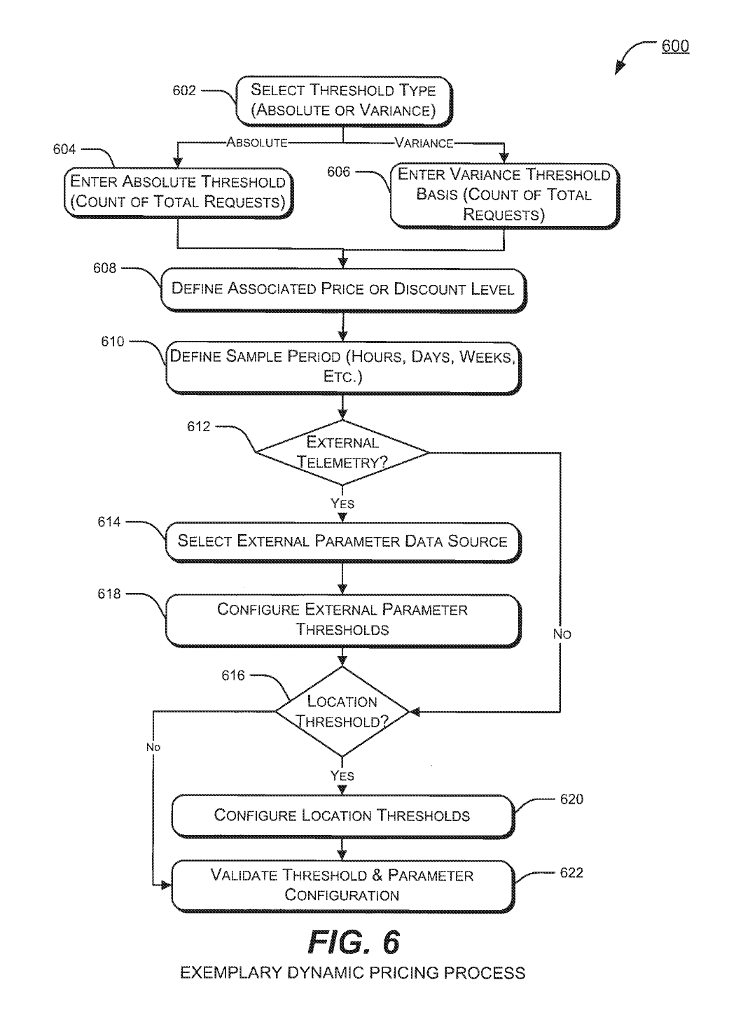

FIG. 6 illustrates an exemplary method 600 for developing campaign content. As described previously, campaign content includes definition of threshold values, external data, location-based prices or discounts, etc. The developer interface 212 may be a web application where developers 110 can login to create the campaign thresholds. Alternatively, the developer interface 212 may be an installable computer application that retrieves and transmits data from and to the threshold module 204. A campaign may be altered, deleted, added, or modified at any time deemed fit by the developer 110. For instance, an organization may withdraw any sale or discount scheme immediately in case of inventory destruction (warehouse fire, accident), financial crisis, etc. Moreover, an organization can add a new campaign on the fly relatively easily as compared to setting up traditional sale campaigns.

At step 602, the developer 110 is requested to select a threshold type—absolute or variance. If the developer 110 selects absolute, the threshold module 204, at step 604, requests the developer 110 to enter a discrete threshold value that defines the threshold as compared to the price query count over a defined sample period, such as 50 price queries per hour, 100 price queries per day, or 1000 price queries per week. If, on the other hand, variance is selected, at step 606, the developer 110 is requested to enter a target value along with one or more variance threshold values that can be a discrete offset from the threshold value or a percentage offset from the target value. For example, the developer 110 may set the variance target as 100 price queries. For both these threshold types, the developer 110 may set more than one unique threshold values or target, which can be progressive and have different pricing levels/discounts associated with them. This allows the developer 110 to utilize a “ladder” approach that ensures the most appropriate discount based on the assessed price queries.

Next, at step 608 the threshold module 204 requests the developer 110 to define the associated price or discount level for each threshold. Proceeding to step 610, the developer 110 is requested to define a sample period. This value is used to filter the price query information retrieved from the transaction database 206. The sample period may be any value in minutes, hours, days, week, or months. This configurable sample period allows the developer 110 to implement pricing or discount algorithms of various degrees of data freshness.

Next, the method 600 determines whether the developer 110 wishes to add any external parameter thresholds at step 612. If yes, the method 600 proceeds to step 614, else the method 600 proceeds to 616 where the threshold module 204 determines whether the developer 110 wishes to add any location based thresholds. At step 614, the threshold module 204 requests the developer 110 to select external parameter data sources from a dropdown list or a list of options available on the developer interface 212. In the next step, the developer 110 configures the thresholds for the selected external parameters and proceeds to step 616. Here, if the developer 110 wishes to add location based thresholds, the method 600 proceeds to step 620 where the user enters location-based thresholds from a list of configurable thresholds. Alternatively, the developer 110 may develop location thresholds from scratch. Once the thresholds are validated and saved (at step 622), the threshold values, sample period, and external threshold data may be provided to the pricing engine 104 over a network connection. This data may be stored in the transaction database 206.

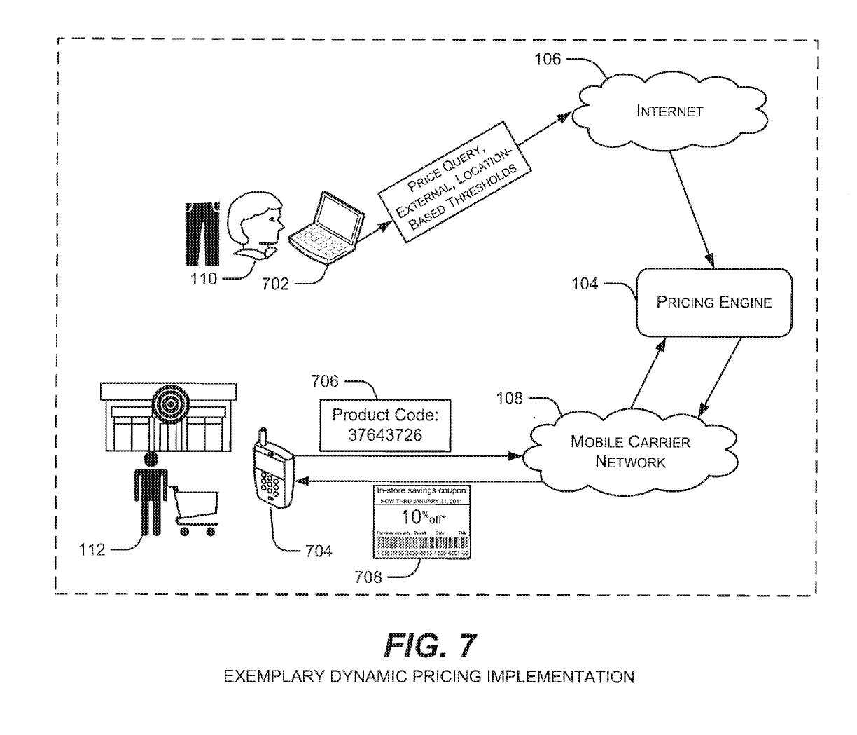

For purposes of clarity, the application of the pricing engine 104 will be described in an example set out here. FIG. 7 is a block diagram illustrating this implementation. Here, a clothing manufacturer wishes to introduce a national campaign not only to increase the total sales volume of their denim-line sold over one month, but also to achieve optimal pricing at the same time. Their campaign developer 110 logs into the developer interface 212 to create the campaign content specific for the denim promotion from a laptop 702. The campaign developer 110 configures the target price query count for each day along with the daily variance levels. The developer 110 also establishes the associated discount value for each standard deviation from optimal. In addition to the price query thresholds, the manager sets a number of external and location based threshold—she sets a rule that increases the offered discount by 5% if the local temperature increases by 5 degrees and sets lower discounts in colder regions (e.g., Wisconsin) as compared to warm regions (e.g., Arizona). Finally, the developer assigns weights to the different thresholds such as 70% weightage to price query thresholds, 20% to location based, and 10% to external parameter thresholds. This campaign content is stored in the transaction database 206.

A consumer 112 goes into Target in Atlanta for her monthly shopping. Upon entering the denim section, a sign near the campaigned denim space encourages her to type 55555 into an application on her cell phone 704 to determine the discount available on the denims. The consumer's cell phone transfers the price query 706 to the pricing engine 104.

The pricing engine 104 stores this query 706 in the transaction database 206, retrieves all the price queries received for denims in the last 1 day, and extracts the price query, external, and location-based thresholds. The pricing engine 104 compares the price query count for the last 1 day with the price query target to determine the variance of the price query count from the optimal value. The pricing engine 104 also determines the customer's location from the GPS information of her cell phone and applies the location-based thresholds on this location. Next, the pricing engine 104 obtains the current temperature in Atlanta and compares this temperature to the external parameter threshold. Assigned weights are applied to the price discounts corresponding to the compared thresholds and a final discount is calculated. The pricing engine 104 returns a 10% off e-Coupon 708 for the denims because the price query count for the denims was one standard deviation below the optimal query threshold. The customer 112 picks up a pair of denims, and redeems her e-Coupon 708 at the checkout station by scanning her e-Coupon barcode, which is displayed on her cell phone 704 display.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include all forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The specification has described a system and method suitable for providing real-time dynamic pricing information for products. The foregoing description of the exemplary embodiments has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the systems and their practical application to enable others skilled in the art to utilize the systems and various embodiments and with various modifications as are suited to the particular use contemplated. Alternative embodiments will become apparent to those skilled in the art to which the present disclosure pertains without departing from their spirit and scope. Accordingly, the scope of the present inventions is defined by the appended claims rather than the foregoing description and the exemplary embodiments described therein.

What is claimed is:

1) A computer-implemented method for providing real-time dynamic pricing information for a product, the method comprising:
receiving a price query for a product;
maintaining a database of received price queries;
retrieving preset price query threshold values associated with the product;
extracting price query count for the product, the price query count being the number of price queries generated in a predefined sample period; and
calculating a product price based on a comparison between the price query count and the threshold values.

2) The computer-implemented method of claim 1 further comprising generating a time-bound coupon based on the product price.

3) The computer-implemented method of claim 2 wherein the coupon is at least one of an electronic coupon, or a printed coupon.

4) The computer-implemented method of claim 1 further comprising:
configuring the price query threshold values, the price query thresholds being at least one of absolute type or variance type thresholds;
defining the sample period;
configuring an external parameter threshold value;
configuring a location-based threshold value;
defining a price or discount level associated with the threshold values.

5) The computer-implemented method of claim 4, wherein the thresholds have at least one of absolute or variance based value.

6) The computer-implemented method of claim 4, wherein the thresholds are associated with a defined group of products and the defined price or discount level is based on the comparison between the total price query count for all products in the group and the defined threshold values for the group of products.

7) The computer-implemented method of claim 4, wherein variable weights are applied to the thresholds.

8) The computer-implemented method of claim 4 further comprising:
retrieving preconfigured external parameter thresholds and associated price levels, wherein the external parameters include at least one of weather, consumer price index, monthly sales for retail and food services, inventories and sales, monthly wholesale trade, or new residential construction;
retrieving external parameter information in real-time; and
comparing the external parameter thresholds with the external parameter information to determine the appropriate price level.

9) The computer-implemented method of claim 4 further comprising determining the location of the product or consumer.

10) The computer-implemented method of claim 8 further comprising:
retrieving predefined location-based thresholds and associated price levels;
retrieving the location of the product or consumer;
comparing the location based thresholds with the location of the product or consumer to determine the appropriate price level.

11) The computer-implemented method of claim 1, further comprising logging transaction completion information if a consumer completes a transaction using the coupon.

12) The computer-implemented method of claim 10 further comprising determining a consumer profile based on at least one of number of price queries generated by the consumer, or number or transactions completed.

13) The computer-implemented method of claim 11 further comprising providing an additional discount based on consumer profile.

14) A system for providing real-time, dynamic pricing, the system comprising:
an input module for receiving a price query for a product;
a transactional database for storing received price queries;
a dynamic pricing module for:
extracting a price query count from the transactional database, the price query count being the number of price queries related to the product in a predefined sample period;
retrieving preset threshold values for one or more parameters associated with the product;
calculating a product price based on a comparison between the price query count and the threshold values; and
a content generation module for generating a coupon displaying the product price.

15) The system of claim 11 wherein the transaction database logs the current demand information including at least one of the product price query, or transaction record if a consumer completes a transaction using the coupon.

16) The system of claim 11 further comprising a consumer interface allowing a consumer to configure the threshold values for the parameters, wherein the parameters include number of product queries, number of completed transactions, local whether, economic conditions, inventory, or location.

17) The system of claim 11 further comprising a third party data source providing third party content including whether information, traffic data, RSS feeds, social networking content, or economic data.

18) The system of claim 11 further comprising a delivery module for providing the coupon to the consumer.

19) The system of claim 15, wherein the delivery module includes at least one of a mobile platform, or a stationary platform.

20) The system of claim 11 further comprising a location identification module for determining the originating location of the query.

21) The system of claim 11 further comprising a consumer database for storing consumer pertinent information.

22) The system of claim 18 further comprising a profiler for profiling consumers based on the consumer pertinent information.

23) The system of claim 19 further comprising a discount calculator for providing a discount based on the consumer profile.

24) In a system for providing product pricing information to a consumer through a mobile communication platform, a method for providing real-time, demand-based, dynamic pricing information to the consumer, the method comprising:
receiving price query for a product from the consumer;
retrieving preset demand-based threshold values for one or more parameters associated with the product;
maintaining a database of current demand information based on at least one of received product price queries or completed transactions;
extracting current demand information about the product from a specified period;
calculating a product price based on a comparison between the current demand information and the threshold values; and
generating a time-bound electronic coupon, based on the product price, for the consumer;
whereby the consumer completes a sale transaction using the time-bound electronic coupon before expiry of the electronic coupon.
